(19) United States
(12) Patent Application Publication
(10) Pub. No.: US 2014/0019109 A1
(43) Pub. Date: Jan. 16, 2014

(54) ALLELIC DETERMINATION

(71) Applicants: Gilean McVean, Oxford (GB); Stephen James Leslie, Melbourne (AU); Peter James Donnelly, Oxford (GB)

(72) Inventors: Gilean McVean, Oxford (GB); Stephen James Leslie, Melbourne (AU); Peter James Donnelly, Oxford (GB)

(21) Appl. No.: 13/891,739

(22) Filed: May 10, 2013

Related U.S. Application Data
(63) Continuation of application No. 12/664,276, filed on May 28, 2010, now abandoned.

(30) Foreign Application Priority Data
Jun. 15, 2007 (GB) 0711670.0
Aug. 22, 2007 (GB) 0716401.5

(51) Int. Cl. G06F 19/12

(52) U.S. Cl. CPC G06F 19/12
USPC 703/11

(57) ABSTRACT

A method of determining an allelic type of a specific individual, comprising:
accessing a database of genetic information on a plurality of individuals, the genetic information comprising: the allelic type of each individual; and the type of each of a plurality of genetic markers for each individual;
categorizing the data in the database into a plurality of groups of individuals, such that all individuals having the same allelic type are in the same group, and each group represents a different allelic type;
inputting data comprising the type of each of a plurality of genetic markers of the specific individual having an unknown allelic type;
specifying a set of genetic markers for which type information is known both for the individuals in the database and for the specific individual;
applying a population genetic model to calculate the likelihood of sampling, from some or all of the groups in turn, the input type data of the specified set of genetic markers for the specific individual; and
determining the allelic type of the specific individual based on the calculated likelihoods.

The present invention relates to determining genetic information, such as, but not exclusively, allelic type. One particular application relates to acquiring HLA allelic type information, as discussed below, but the invention is not limited to HLA alleles.

The major histocompatability complex (MHC) is probably the most intensely studied region of the human genome due to its vital role in the immune system. It is the most allelically diverse and gene-rich region of the genome, and more human diseases are associated with this region than any other. More than half the genes found in the MHC have known immunological functions and more human diseases are associated with this region of the genome than any other.

The most important of the MHC genes are the Human Leukocyte Antigen (HLA) genes, of which there are two main classes known as Class I and Class II. The proteins produced by the HLA genes are crucial for the functioning of cell-mediated immunity. These genes form a vital part of the body's mechanism for differentiating ‘self’ (i.e. the body's own cells) from ‘non-self’ (e.g. cancer cells, viruses, fungi, protozoa and intracellular bacteria).

The HLA genes possess a remarkable level of allelic diversity compared to the rest of the genome, with several of the genes having hundreds of known allelic types. This, along with the role played by the HLA genes in the immune system, has led to great interest being shown in the region by evolutionary biologists and theoreticians.

More importantly to most biomedical researchers, particular HLA alleles have been shown to have strong associations with serious autoimmune diseases which affect the health of millions of people worldwide (e.g. insulin-dependent (type 1) diabetes, rheumatoid arthritis, Graves' disease, multiple sclerosis and ankylosing spondylitis). Furthermore, it is known that some HLA alleles confer protection from certain communicable diseases such as cerebral malaria and the development of AIDS in HIV infected individuals. Clearly, for many large-scale studies, knowing the HLA types of the individuals in the study is extremely valuable. These include disease-association studies, vaccine trials and other epidemiological studies where HLA type can be a potential causal or confounding factor. Also of great significance is the role these genes play in the acute rejection of transplants—HLA mismatch can lead to the destruction of transplanted tissue by the body's immune system.

Given the above considerations, accurate allelic typing is of the utmost importance for scientists researching human disease genetics and evolution. Current methods for typing HLA alleles are very expensive and time consuming, limiting the availability of these important data to small studies. Furthermore, even when HLA typing is performed, this is often restricted to a few loci. There is great demand from researchers for an accurate, inexpensive method to perform this task. Unfortunately, given the incredible allelic diversity of the HLA genes and the large number of rare types, developing such a method is far from straightforward. There are considerable mathematical challenges in creating suitable models, and interesting statistical issues in developing methods for inference in this context. Until now, no suitable method has been found.

Recent large-scale surveys of genetic variation within the extended human MHC have demonstrated that single nucleotide polymorphisms (SNPs) and other putatively neutral markers within the region can show strong linkage disequilibrium to particular HLA alleles. Because SNPs are relatively inexpensive to genotype, SNP-based tagging offers an attractive alternative to conventional HLA-typing where 100% accuracy in allele typing is not required (e.g. in testing for association or initial screening of a large database of potential transplant donors). However, while these earlier studies indicated that some common HLA alleles may be efficiently tagged with one or two SNP markers, the conventional notion of tagging does not provide a general solution to accurate determination of classical HLA variation. Firstly, the majority of HLA alleles are rare, so ‘common’ SNPs, or even combinations of two or three such SNPs, typically cannot provide the resolution needed to identify them. Secondly, many HLA alleles are found on multiple haplotype backgrounds, so that no single SNP or combination of SNPs can act as reliable proxies. Third, the large number of HLA alleles requires that large numbers of tags must be typed. Fourth, identification of tags in relatively small samples can lead to problems of over-fitting (i.e. the tags will not transfer well to future studies). Such over-fitting may have serious consequences for methods using a tagging approach. In particular, tagging approaches are inherently unstable as the inclusion of a single new individual in the tag identifying algorithm may cause the selected tags to be changed completely and thus invalidate previous analyses. Therefore the tagging approach has problems and drawbacks.

It is an object of the invention to alleviate, at least partially, some or any of the above problems. Accordingly, the present invention provides a method of determining an allelic type of a specific individual, comprising:

accessing a database of genetic information on a plurality of individuals, the genetic information comprising: the allelic type of each individual; and the type of each of a plurality of genetic markers for each individual;

categorizing the data in the database into a plurality of groups of individuals, such that all individuals having the same allelic type are in the same group, and each group represents a different allelic type;

inputting data comprising the type of each of a plurality of genetic markers of the specific individual having an unknown allelic type;

specifying a set of genetic markers for which type information is known both for the individuals in the database and for the specific individual;

applying a population genetic model to calculate the likelihood of sampling, from some or all of the groups in turn, the input type data of the specified set of genetic markers for the specific individual; and

determining the allelic type of the specific individual based on the calculated likelihoods.

The invention also provides a method of selecting a set of genetic markers for use in determining an allelic type of a specific individual, the method comprising:

accessing a database of genetic information on a plurality of individuals, the genetic information comprising: the allelic type of each individual; and the type of each of a plurality of genetic markers for each individual;

initialising to define a current set of genetic markers;

determining the allelic type of each individual in the database using the current set of genetic markers;

measuring the performance of the current set of markers by calculating a predetermined performance measure on the basis of the allelic types found in the determining step and the actual allelic types known from the database;

keeping as the current set of markers the set that gives the best measured performance seen so far for a set of a given size;

modifying the current set of markers;

repeating the determining, measuring, keeping and modifying steps;

terminating when a predetermined condition is met; and

outputting the set of markers that gives the best measured performance seen as the selected set of genetic markers for use in determining an allelic type of an individual.

The invention further provides a kit, computer program, and computer system for use with the above method, as defined in the appended claims.

Throughout this description the term “determination” or related expressions is understood to mean, for example, assigning an allelic type to a chromosome or classifying chromosomes by allelic type, and so forth.

Embodiments of the invention will now be described, by way of example only, with reference to the accompanying drawings, in which:

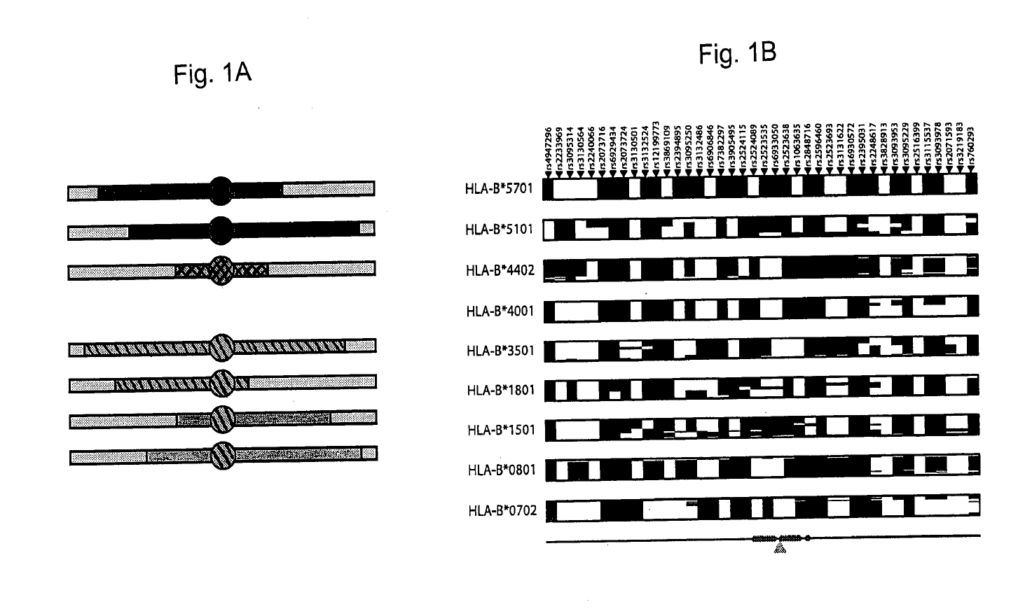

FIG. 1A illustrates schematically chromosomes carrying alleles on various haplotype backgrounds;

FIG. 1B shows different SNP haplotypes for several HLA-B alleles;

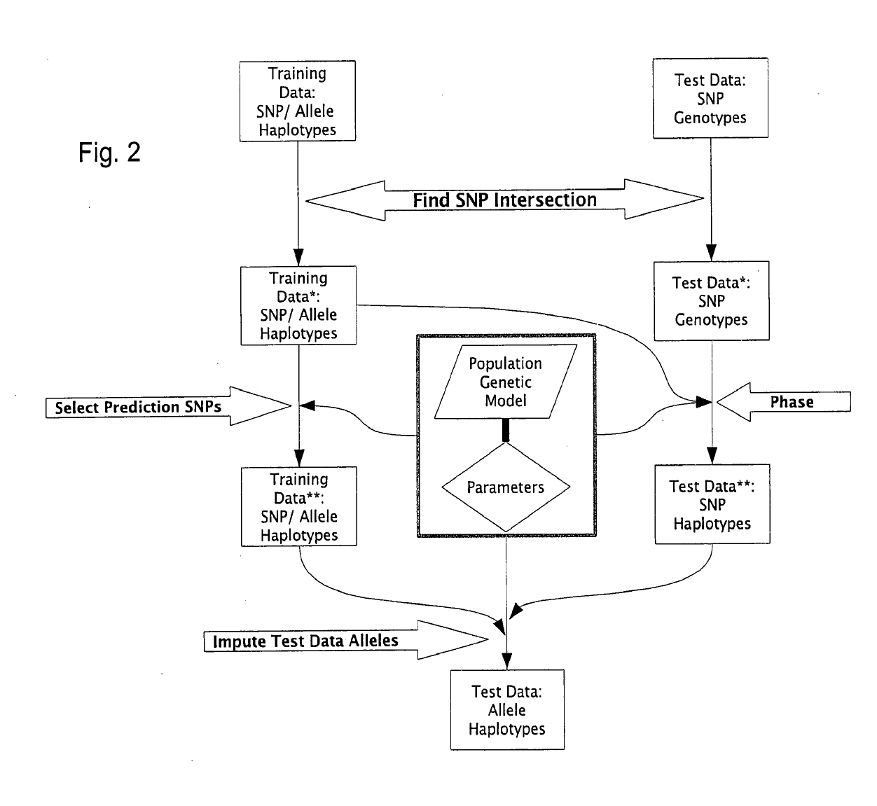

FIG. 2 is a flow chart illustrating methods embodying aspects of the invention;

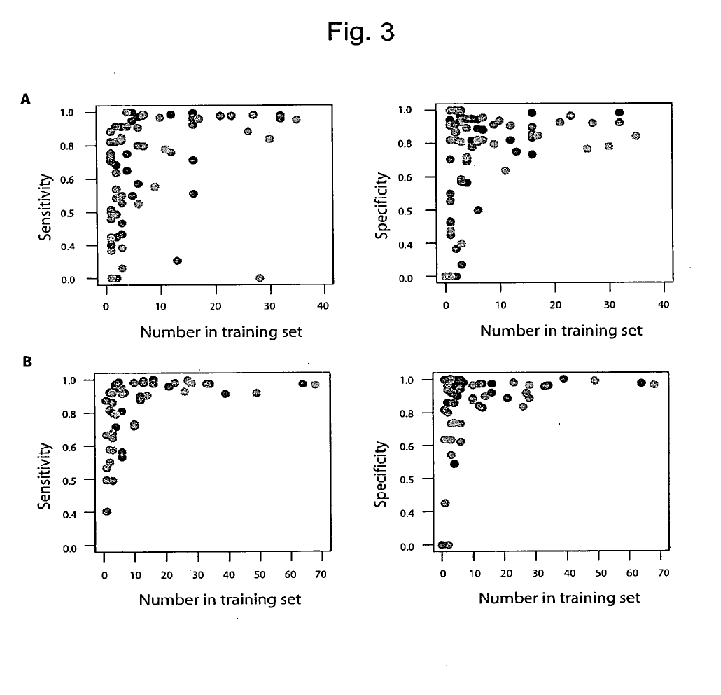

FIG. 3 gives plots of the relation between the number of times an allele appears in a database of training data and the sensitivity and specificity of the results; and

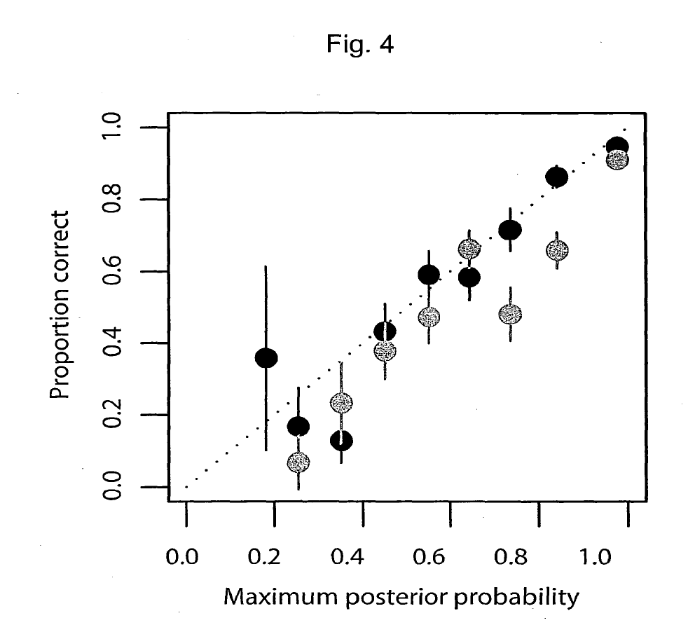

FIG. 4 is a graph of proportion of correct allelic determinations against maximum posterior probability, showing a method embodying the invention is well calibrated.

The strong haplotype structure observed across the MHC region lends itself to an alternative approach to tagging for determining HLA types (see FIG. 1A). Consider two chromosomes that are identical by descent (IBD) at a particular HLA locus through sharing a common ancestor 100 generations ago. We would expect identity by descent to extend 1 cM either side of the HLA locus, which in a region where the average recombination rate is 0.4 cM/Mb, predicts identity over 5 Mb. Such a large region of identity should be detectable through the use of SNPs genotyped across the region and not even particularly close to the HLA locus or chosen specifically for their ability to tag. Consequently, if two chromosomes show such extensive SNP identity extending across an HLA locus, we would expect them to share the same HLA allele. Comparison of SNP data from individuals with unknown HLA types to a database of haplotypes from individuals with known HLA types can potentially provide an accurate approach to determining the HLA types.

FIG. 1A is a schematic representation of IBD-based imputation. In the upper part two chromosomes carrying the same allele (black circle) share extended similarity with a recent common ancestor (black segments) and therefore also each other. A second, but related, allele (cross-hatched circle—e.g. one that is identical at 2-digit resolution) shares more limited and divergent, but nevertheless detectable, similarity. In the lower part of the FIG. 1A the same allele (diagonally hatched circle) sits on two distinct haplotype backgrounds (the upper two and the lower two, respectively). A conventional tagging approach would both fail to identify the more distant relatedness between alleles in the upper part and will fail to identify a single tag-set in the lower part.

The importance of using an IBD-based methodology, as opposed to a conventional tagging approach to determine HLA alleles is demonstrated in FIG. 1B, which shows haplotypes for chromosomes carrying different HLA-B alleles in a sample of 180 chromosomes from a population of European ancestry. In FIG. 1B, SNP haplotypes for HLA-B alleles at 4-digit resolution (defined below) with 5 or more copies in the CEU training data at the 40 SNPs chosen for the determination of HLA types for the Affymetrix array data on the 1958 Birth Cohort (see Appendix); each row represents a unique chromosome and the alleles at the SNPs are arbitrarily coded as black and white. Note that unlike a conventional tagging approach, there is typically no unique haplotype that defines the presence of an allele. rsIDs are indicated above and the location of the SNPs used for the determination relative to HLA-B within the approximately 4 Mb HLA region (defined here as the region from SNPs rs7754054 to rs769051) is shown below. In a tagging approach we would expect to see a ‘bar-code’ effect, with each allele being associated with a single tagging haplotype. While this is largely the case for some alleles (e.g. HLA-B*5701, HLA-B*4001 and HLA-B*0702), for others (e.g. HLA-B*1801 and HLA-B*1501) the allele lies on multiple haplotype backgrounds (in HLA nomenclature the first two digits indicate the serological group and the second two indicate the unique protein within that group. There is a further classification, six digit, where the first four digits are as described, and the final two indicate DNA sequence equivalence (or not)). Conversely, very rarely do we observe different HLA alleles on the same SNP haplotype. Consequently, each allele can potentially be determined from the combination of haplotype backgrounds on which it is found to occur. These haplotype backgrounds are known, in some cases, to differ between populations (e.g. different ethnic groups or individuals from different geographic locations). Below we describe a novel statistical methodology for determining the HLA allelic types of chromosomes for which we have SNP information, using a database of SNP haplotypes carrying known HLA alleles. We describe its performance on a set of previously published ‘training data’ (90 individuals of European ancestry from Utah (CEU) and 60 Yoruba from Ibadan in Nigeria (YRI)) using a leave-one-out cross-validation strategy to choose classification SNPs and to estimate performance. We then validate the methodology by determining HLA alleles in a set of over 900 individuals of UK origin and demonstrate accuracies approaching 95% at 2-digit resolution across even the most polymorphic loci. Finally, we describe how to selectively enhance the existing database so as to give substantial improvements in determination accuracy.

### Specific Model Approach

We now describe a method according to an embodiment of the invention used for determining HLA allelic types from SNP data. We focus on one HLA gene locus and the possible alleles at that locus. It is a simple matter to combine information across loci.

Our starting point is a training database consisting of SNP genotypes across the extended MHC and classical HLA alleles for n chromosomes from a plurality of individuals (the classical HLA genes are the most commonly studied of the Class I and Class II genes. They include the Class I genes HLA-A, HLA-B and HLA-C and the Class II genes HLA-DPA1, HLA-DPB1, HLA-DQA1, HLA-DQB1, HLA-DRA, and HLA-DRB1). We assume that haplotype phase for both SNP data and classical HLA types is known or estimated (for example, from a combination of pedigree data and statistical approaches). In this example, we access this database in which the SNP haplotypes are categorized by the HLA allele associated with that haplotype. Furthermore, we assume that there is no missing SNP data in the database (for example, it has also been inferred through a combination of pedigree information and statistical methods). We exclude from the database any chromosome for which the allele at the classical HLA locus of interest is missing. Extending the method to incorporate both genotype data and missing data is in principle straight forward, but in the specific case we consider here, unnecessary. Uncertainty concerning phase and missing data can be accommodated by, for example, averaging predictions over multiple samples from the posterior distribution of phased data-complete chromosomes given a suitable model. Both haplotype phase and missing data can also be imputed naturally within the running of the algorithm using the model specified. In fact the method may be simply extended to incorporate determination of, for example, missing data, haplotype phase and HLA allelic type in an iterative approach. However, here we consider the use of a single estimate.

We now input SNP genotype data for an additional m individuals typed across the same region. Let/be the number of SNPs for which there is genotype information for both the training database and additional individuals. Our allele determination method has three stages. In the first stage (specifying step) we select, from among the l SNPs, a set of size lₚ that can be optimal (in a way defined below), but need not necessarily be optimal, for determining HLA alleles at a specified locus of interest within the training database chromosomes, using a cross-validation procedure (we call this the classification SNP set, CSS). In the second stage, haplotype phase and missing data are estimated for the l SNPs in the additional individuals. In the third stage, probabilistic statements are made about the allele carried by each of the 2 m additional chromosomes by comparing these, one at a time, with the database chromosomes at the selected lₚ SNPs. A flow chart summarising the process can be found in FIG. 2.

At the core of the methodology is a method for calculating the probability that a particular chromosome carries a given allelic type given the known SNP haplotype of the chromosome and a set of training data (where we know both the SNP haplotype of each chromosome, as well as the alleles carried by each chromosome). The technical details of this algorithm are given in the next section.

The method of the invention uses a population genetic model. A population genetic model provides a mathematical description of patterns of genetic variation within natural populations. A population genetic model specifically refers to any description of how fundamental processes (including mutation, recombination, genetic drift, demographic history) interact to generate a distribution of sampled variation. A population genetics model is distinguished from a purely statistical model because it is characterised by mathematical models of the underlying process, rather than simply modelling the observations directly. A population genetics model may be characterised either through specifying the joint probability of observing a set of data, or the conditional probability of observing additional data given some pre-existing information.

The Determination Algorithm

An allele determination algorithm for a single additional phased chromosome with no missing SNP data is central to first and third stages. We therefore describe this part first. Considering a particular HLA locus, we group chromosomes in the database by the HLA allele they carry. This can be done at either the 2-digit or 4-digit level (or coarser, such as super-family, or finer, such as 6-digit). Suppose there are K different alleles represented in the training database for the locus in question. For each of the K alleles, we calculate an approximation to the probability (under a mathematical model called the coalescent) of observing the SNP configuration at the classification SNP set in the additional chromosome if it also carried the same HLA allele. According to this specific embodiment of the invention, the population genetic model used is an approximation to the coalescent which uses a hidden Markov model (HMM) formulation that allows efficient computation [Li, N and Stephens, M (2003) Modelling linkage disequilibrium and identifying recombination hotspots using single nucleotide polymorphism data, Genetics 165:2213-2233], but other population genetic models could be used. Informally, the method assumes that if the additional chromosome carries a given HLA allele, it will look like an imperfect mosaic of those chromosomes that carry the same allele (the hidden state being which of those chromosomes in the database is the ‘parent’ of the ‘daughter’ additional chromosome at any given position). The degree of mosaicism is determined by the recombination rate and the number of chromosomes in the database that carry the allele. The degree of imperfection (mismatch in SNP haplotype) is also determined by the mutation rate.

More formally, let A be the set of all different alleles at a given locus in the database and |A|=K. Suppose that there are nₐ copies of allele a in the database. The training database consists of n known haplotypes where the jth haplotype has the SNP information at l SNPs, c^{j}={c₁^{j}, c₂^{j}, . . . , cₗ^{j}}, and the classical HLA allele a^{j}. Each additional chromosome, i, (with unknown HLA allele) has SNP information hⁱ={h₁ⁱ, h₂ⁱ, . . . , hₗⁱ}. We seek to determine the HLA allelic type of this chromosome, based on its SNP haplotype and the information in the training database. We require a fine-scale genetic map of the region, r={r₀, r₁, r₂, . . . , rₗ} where rⱼ₊ₗ−rⱼ is the average rate of crossover per unit physical distance per meiosis between sites j and j+1 times the physical distance between those sites; we use that previously estimated from genetic variation data and set r₀=0. Note that the SNPs (and the map) are ordered by the position of the SNP (or map point) on the chromosome (for convenience we refer to the first SNP position as the leftmost position and the lth SNP position as the rightmost).

We now focus on a specific allele a and only those chromosomes carrying this allele in the training data. For this set of chromosomes we define the recombination probability between sites s and s+1 to be pₛ=1−exp{−4Nₑ(rₛ₊₁−rₛ)/nₐ} and then define transition probabilities from state j (indicating that it is the jth haplotype of those in the database that carry allele a that is parental) at position s to state k at position s+1:

$$q ( {j}_{s} , {k}_{s + 1} ) = \{ \begin{matrix}1 - {p}_{s} + {p}_{s} / {n}_{a} & j = k \\ {p}_{s} / {n}_{a} & j \neq k ,\end{matrix}$$

where Nₑ is the effective population size (here assumed to be 15,000 though we found results to be largely insensitive to the value of this parameter within a factor of two). We define the emission probabilities in terms of the ‘population mutation rate’ for allele a

$${θ}_{a} = {( {\sum }_{z = 1}^{{n}_{a} - 1} 1 / z )}^{- 1} ,$$

and the mismatch (or not) between the SNP allele of the jth ‘parent’ chromosome at SNP s, cₛ^{j}, and the SNP allele of the ith additional ‘daughter’ chromosome, hₛⁱ

$$e ( {h}_{s}^{i} , {c}_{s}^{j} ) = \{ \begin{matrix}\frac{{n}_{a}}{{n}_{a} + {θ}_{a}} + \frac{1}{2} \frac{{θ}_{a}}{{n}_{a} + {θ}_{a}} & {h}_{s}^{i} = {c}_{s}^{j} \\ \frac{1}{2} \frac{{θ}_{a}}{{n}_{a} + {θ}_{a}} & {h}_{s}^{i} \neq {c}_{s}^{j} .\end{matrix}$$

To calculate the conditional probability of observing the additional haplotype we sum over all possible paths through the potential parental chromosomes using the forward algorithm. For each of the nₐ database chromosomes carrying allele a, we initialise the forward algorithm:

f₁^{j}=1/nₐ×e(h₁ⁱ,c₁^{j}).

The forward algorithm moves along the sequence such that at each SNP s, where 1<s≦l,

$${f}_{s}^{j} = e ( {h}_{s}^{i} , {c}_{s}^{j} ) {\sum }_{k = 1}^{{n}_{a}} {f}_{s - 1}^{k} \times q ( {k}_{s - 1} , {j}_{s} ) .$$

The probability of observing the SNP configuration of the additional chromosome, assuming that it carries allele a, is given by

$$π ( {h}^{i} \vert a ) = {\sum }_{j = 1}^{{n}_{a}} {f}_{l}^{j} .$$

A similar calculation is made for each of the K alleles. The posterior probability that the additional chromosome carries allele a is given by Bayes rule:

$$Pr ( a \vert {h}^{i} ) = \frac{Pr ( a ) π ( {h}^{i} \vert a )}{{\sum }_{b ∈ A}^{ } Pr ( b ) π ( {h}^{i} \vert b )} ,$$

where for each allele a in the database, we define the prior probability of carrying a, Pr(a), to be 1/K. Weighting by the frequency of an allele in the training database was also considered and performed similarly. The argument for weighting equally is that it guards against determinations being strongly influenced by biases in the allelic representation of the database. Clearly it is a simple matter to incorporate different prior information into the model if required. The allele carried by the additional chromosome is determined by selecting the group with the highest posterior probability. However, we also consider a scheme whereby we only make a determination if the maximum posterior probability for any group is greater than or equal to some call threshold: 0<t≦1. This approach guards against making determinations where there is much uncertainty about HLA allele carried by the additional chromosome. Where there are multiple chromosomes with unknown alleles, determinations are made for each additional chromosome separately. We also make determinations for each locus separately. We refer to this model as the Whole-Haplotype Model (WH Model).

It is worth noting that we also considered a variation on this algorithm, the Gene Localized Model (GL Model), which worked well in preliminary investigations, but was not as effective as the algorithm just described. For this algorithm, rather than stratifying the training data into chromosomes carrying specific allelic types at the beginning of the procedure, we perform the stratification at the end. In this case for each new chromosome we seek to determine the ‘parent’ chromosome at the HLA gene locus of interest—we use the parent's allelic type to assign the allelic type to additional chromosomes. More precisely, the training database consists of n known haplotypes where the jth haplotype has the SNP information at l SNPs, c^{j}={c₁^{j}, c₂^{j}, . . . , d^{j}, . . . , cₗ^{j}}, and define g to be the position of the chromosome's classical HLA allele a^{j}. Each additional chromosome, i, (with unknown HLA allele) has SNP information hⁱ={h₁ⁱ, h₂ⁱ, . . . , gⁱ . . . , hₗⁱ}, where, as before, g is the position of the chromosome's classical HLA allele (with unknown type). We seek to determine the HLA allelic type of this chromosome, based on its SNP haplotype and the information in the training database. We require a fine-scale genetic map of the region (defined as before), r={r₀, r₁, r₂, . . . , r_{g}, . . . , rₗ}; where r_{g} indicates the map value at the position of the gene locus (for convenience we refer to the first SNP position as the leftmost position and the lth SNP position as the rightmost). Note, as before, the SNPs and map are ordered by the position of the SNP (and the gene locus) on the chromosome. We use a map previously estimated from genetic variation data and set r₀=0. We define the recombination probability between sites s and s+1 to be pₛ=1−exp{−4Nₑ(rₛ₊₁−rₛ)/n} and then define transition probabilities from state j (indicating that it is the jth haplotype in the training database that is parental) at position s to state k at position s+1:

$$q ( {j}_{s} , {k}_{s + 1} ) = \{ \begin{matrix}1 - {p}_{s} + {p}_{s} / n & j = k \\ {p}_{s} / n & j \neq k ,\end{matrix}$$

where Nₑ is the effective population size (again assumed to be 15,000). We define the emission probabilities in terms of the ‘population mutation rate’

$$θ = {( {\sum }_{z = 1}^{n - 1} 1 / z )}^{- 1} ,$$

and the mismatch (or not) between the allele of the jth ‘parent’ chromosome at SNP s, cₛ^{j}, and the allele of the ith additional ‘daughter’ chromosome, hₛⁱ

$$e ( {h}_{s}^{i} , {c}_{s}^{j} ) = \{ \begin{matrix}\frac{n}{n + θ} + \frac{1}{2} \frac{θ}{n + θ} & {h}_{s}^{i} = {c}_{s}^{j} \\ \frac{1}{2} \frac{θ}{n + θ} & {h}_{s}^{i} \neq {c}_{s}^{j} .\end{matrix}$$

We do not define a mismatch probability at the gene locus, but set the emission probability to be one at this position.

To calculate the conditional probability of observing the additional haplotype we consider all possible paths through the potential parental chromosomes. Using the forward algorithm for all SNPs to the left of the gene locus, and the equivalent backward algorithm for all sites to the right, we calculate the probability that the ith daughter chromosome hⁱ is a copy of the jth ‘parent’ chromosome (in the training database) at the gene locus. In particular, for each of the n database chromosomes, we initialise the forward algorithm:

f₁^{j}=1/n×e(h₁ⁱ,c₁^{j}).

The forward algorithm moves along the sequence such that at each SNP s, where 1<s≦l,

$${f}_{s}^{j} = e ( {h}_{s}^{i} , {c}_{s}^{j} ) {\sum }_{k = 1}^{n} {f}_{s - 1}^{k} \times q ( {k}_{s - 1} , {j}_{s} ) .$$

Similarly, we initialise the backward algorithm:

bₗ^{j}=1/n×e(hₗⁱ,cₗ^{j}).

The backward algorithm moves along the sequence such that at each SNP s, where 1≦s<1,

$${b}_{s}^{j} = e ( {h}_{s}^{i} , {c}_{s}^{j} ) {\sum }_{k = 1}^{n} {b}_{s + 1}^{k} \times q ( {j}_{s} , {k}_{s + 1} ) .$$

Then, the probability of copying the jth ‘parent’ chromosome at the gene locus is given by

u_{g}^{j}=f_{g}^{j}+b_{g}^{j},

where the forward algorithm is run from the first SNP to the gene locus g and the backward algorithm from the lth SNP to the gene locus.

We then define probability of observing the SNP configuration of the additional chromosome, if it was assumed to be carrying allele a by

$$π ( {h}^{i} \vert a ) = {\sum }_{j = 1}^{n} {u}_{g}^{j} \times {I}^{a} ( j ) ,$$

where

$${I}^{a} ( j ) = \{ \begin{matrix}1 , & if the allele carried by chromosome j is a \\ 0 , & otherwise .\end{matrix}$$

A similar calculation is made for each of the K alleles. As before, the posterior probability that the additional chromosome carries allele a is given by Bayes rule:

$$Pr ( a \vert {h}^{i} ) = \frac{Pr ( a ) π ( {h}^{i} \vert a )}{{\sum }_{b ∈ A} Pr ( b ) π ( {h}^{i} \vert b )} .$$

We define the prior probability of carrying an allele, Pr(a), to be nₐ/n, the frequency of an allele in the training database. This is the natural prior for this model, although clearly it is a simple matter to use a different prior. As before, the allele assignment is determined by the group with the highest posterior probability.

We now describe each of the steps of the algorithm in detail. Note that although all tests were performed using one of the models described above (for the most part the first described, WH model), all that is required for the determination algorithm to work is a method for calculating π(hⁱ|a), as then we can define Pr(a|hⁱ).

Stage 1: Selecting a Set of Classification SNPs

Selecting a classification SNP set (CSS) was performed by using a version of leave-one-out cross-validation. Using the whole training set and a given set of SNPs, each haplotype is removed in turn, and the determination algorithm(s) is used to classify the removed haplotype using all of the other sequences as training data. The determined (under the model) HLA type for that sequence is then compared with the known type. Performance (as defined below) is measured considering the determinations made for all of the haplotypes in the training set. Leave-one-out cross-validation was used rather than the more general n-fold cross-validation because the number of sequences in the training data was quite small—particularly considering the number of allelic types for each gene. With a larger training set, n-fold cross-validation would possibly be more appropriate (note: ‘n’ in this context is not the number of chromosomes in the training set—it is standard to refer to ‘n-fold cross validation’).

For each gene locus we limit our search space by SNPs in our training set within 200 SNPs of the locus (approximately 500 kB in the case of the SNPs typed in the training data). Although this restriction to the sites closest to the gene is not necessary, its utility is justified by identity by descent. We seek to select a subset of these 200 SNPs which gives the best performance at classifying HLA alleles, for a given performance measure. It is worth noting that even when restricted to 200 sites the space of all possible CSSs is enormous (2²⁰⁰−1≈1.6*10⁶⁰) and an exhaustive search of this space is not feasible. Consequently a CSS selection algorithm must be utilized.

More formally, we wish to select a set of SNPs, from among the/typed in both the database and additional chromosomes, with which to make determinations about alleles at untyped classical HLA loci. We use a leave-one-out cross-validation scheme within the training database combined with forwards-selection and backwards elimination to select a set of SNPs. For the leave-one-out scheme, we consider each of the chromosomes in the training database separately. Considering the ith database chromosome we set it to be hⁱ, and treat it as though it has unknown allelic type. We temporarily remove it from the training database and make a determination of its allelic type (which we compare with the known value) based on its SNP information and the data in the training database. The measure we use to determine the best set of classification SNPs is a function of the accuracy of determinations in the training set and the call rate (the fraction of chromosomes for which we make a determination). Let t be the call threshold as defined above i.e. the minimum value that the maximum posterior probability must take for a determination to be made. Let I_{call} be the indicator function

$${I}_{call} ( {h}^{i} , t ) = \{ \begin{matrix}1 & {if max}_{a ∈ A} \{ Pr ( a \vert {h}^{i} ) \} \geq t \\ 0 & otherwise ,\end{matrix}$$

and let I_{correct} be another indicator function

$${I}_{correct} ( {h}^{i} , {a}^{i} ) = \{ \begin{matrix}1 & if {argmax}_{a ∈ A} \{ Pr ( a \vert {h}^{i} ) \} = {a}^{i} \\ 0 & otherwise ,\end{matrix}$$

where aⁱ is the known allele carried by the ith chromosome in the training set. (In fact, in the rare case of y alleles having the equal highest posterior probability (where y≧2), we allow I_{correct}(hⁱ,aⁱ)=1/y provided that one of they tied alleles is the known allele and 0 otherwise.) For our cross-validation procedure we define the proportion of chromosomes in the database for which I_{call} (hᵢ,t)=1, to be the call-rate, and the proportion for which I_{correct}(hⁱ,aⁱ)=1 as the accuracy. We say that we call the allelic type of a chromosome (or just that we call the chromosome) hⁱ if I_{call}(hⁱ,t)=1.

As stated above, determinations are made excluding the chromosome in question from the training data (hence the name leave-one-out cross-validation). The quality of a classification SNP set, s={s₁, s₂, . . . , sₗ_{ₚ}}, is defined in terms of the distance from optimal performance (100% call rate and 100% accuracy for those chromosomes for which we make a determination). Here we use the I₁ norm (1−call rate)+(1−accuracy for those chromosomes we call):

$$Q ( s ) = ( 1 - \frac{1}{n} {\sum }_{i = 1}^{n} {I}_{call} ( {h}^{i} , t ) ) + ( 1 - \frac{{\sum }_{i = 1}^{n} [ {I}_{call} ( {h}^{i} , t ) \times {I}_{correct} ( {h}^{i} , {a}^{i} ) ]}{{\sum }_{i = 1}^{n} {I}_{call} ( {h}^{i} , t )} ) ,$$

although other distances (e.g. Euclidean) were considered and performed similarly. Note that in the case that

$${\sum }_{i = 1}^{n} {I}_{call} ( {h}^{i} , t ) = 0 ,$$

i.e. we do not make a determination for any haplotype given the threshold, Q(s) is undefined. In this case we define

$$Q ( s ) = 1 + ( 1 - \frac{{\sum }_{i = 1}^{n} [ {I}_{correct} ( {h}^{i} , {a}^{i} ) ]}{n} ) ,$$

i.e. 2 minus the proportion of sequences correctly assigned without considering the threshold.

In defining possible quality scores it is simple to weight accuracy or call rate to a higher or lesser degree, depending on the application. In this case, the smaller the value the better the performance. In practice we report the values of the call rate and accuracy for those alleles that we call, but the quality measure is required for the implementation of the SNP selection algorithm (see below).

There are many other possible measures. For example we considered both the full likelihood (under the model, given the SNPs we are considering) and the product over all sequences of the posterior probability of the known value. In preliminary work we did in fact use these measures, but changed our focus to the combination of call rate and accuracy as the values are more easily interpreted by the intended users of the method.

The selection algorithm has the following steps (see notes below for dealing with ties and specific issues relating to Q(s)). We set a predetermined stopping condition for the algorithm: m, the number of SNPs to select plus 1 (we add 1 to ensure the backward elimination step is included for the final set of SNPs).

1. Initialise: find the single SNP among the l genotyped with the lowest Q(s) value. Set this SNP to be the current classification set s.

2. Note the current classification set s and its value, Q(s).

3. Forward selection: Identify the set s′=s+sᵢ, where

$$i = {argmin}_{j} \{ Q ( s + {s}_{j} ) \} ,$$

s₁∉s. Note we only consider SNPs within 100 SNPs either side of the HLA locus in question. If s m terminate.

4. Backward elimination: Identify the set s″=s′−sⱼ, where

$$j = {argmin}_{k} \{ Q ( {s}^{′} - {s}_{k} ) \} , {s}_{k} ∈ s .$$

If s″=s, return s′ to step 2. Otherwise, return s″ to step 2.

Note that if two or more sets of SNPs have an equal quality score at any point, ties are resolved first by selecting the set that gives the best value of Q(s) if the call threshold, t, was set to 0, and if the tie still exists the set of SNPs with lowest average distance (in base pairs) from the gene is selected. It is also important to note that if we have a set of SNPs where I_{call}(hⁱ,t)≠0 for at least some i, we always choose such a set rather than one for which I_{call}(hⁱ,t)=0 for every i (i.e. we prefer sets of SNPs where we make at least one call to sets which may have a better value of Q(s), but where no chromosomes are called). This is particularly important in the early iterations of the algorithm as in these stages it is likely that not all sets of SNPs will result in any chromosomes being called, and we want to ‘guide’ the algorithm to sets of SNPs where calling allelic types occurs. Finally, the restriction in Step 3 to SNPs within 100 SNPs either side of the gene locus is unnecessary. The set of SNPs to search within may be any set, provided suitable data exists.

Using this algorithm, and setting m=41, we select 40 SNPs for each gene locus. The classification SNP set chosen is the smallest that achieves the best Q(s) score over the entire algorithm. Classification sets are selected independently for each gene locus. In the following only a value of t=0 was used in selecting the classification set. Other values were considered, but the results did not seem highly sensitive to this parameter.

It is also important to note that because of the high linkage disequilibrium (LD) across the MHC region it is possible to identify a second or third classification set of almost equal quality with little or no SNP overlap (data not shown). Such redundancy is useful because A) not all SNPs can be typed on all platforms and B) effective classification SNP sets can be identified from among SNPs already genotyped that were not specifically selected for determining classical HLA alleles.

Stage 2: Phasing and Imputing Missing Data in the Additional Chromosomes

To reconstruct haplotypes from genotype data and estimate missing data we use a modified version of the algorithm employed in the program PHASE [Stephens, M & Scheet, P (2005) Accounting for decay of linkage disequilibrium in haplotype inference and missing-data imputation. Am J Hum Genet 76:449-462] in which the haplotypes present in the database are treated as ‘known’ haplotypes. Two modifications are employed. First, additional data is treated on an individual-by-individual basis such that each additional individual is phased using only the known haplotypes. Second, as a result of this approach, we can use maximum likelihood (rather than MCMC) to estimate haplotypes for each additional genotype.

Stage 3: HLA Allele Determinations

Having estimated haplotype phase and missing data for each of the additional 2 m chromosomes, probabilistic determinations are made at each HLA locus using SNP information at the previously selected classification set for each locus and the reference database. Determinations are made separately for each population: e.g. only the CEU haplotypes are used as training data when determining additional CEU chromosomes. We also experimented with making determinations using both populations combined. This worked successfully (showing that the method is still very useful when information about the population of origin of chromosomes is unknown), although performance was slightly worse than that observed for population specific determinations. Consequently our main focus was on using population specific training data.

We use two measures of success in assessing determinations: sensitivity (or accuracy) is defined as the proportion of all determinations that are correct and specificity is the proportion of times a given allele, when present, is correctly determined. When validating the method using genotype data, because we do not know the haplotype phase of the classical HLA alleles, slight modifications of these definitions are required. For each individual, i, we define hⁱ={h^{i,1},h^{i,2}}: the ordered pair of phased SNP haplotypes; aⁱ={a^{i,1},a^{i,2}}: the ordered pair of determined alleles (where alleles are determined using the maximum posterior probability) and αⁱ={α^{i,1},α^{i,2}}: the unordered pair of known allelic types (with arbitrarily assigned labels 1 and 2). We define the following indicator functions:

$${I}_{call} ( {h}^{i , j} , t ) = \{ \begin{matrix}1 & {if max}_{a ∈ A} \{ Pr ( a \vert {h}^{i , j} ) \} \geq t \\ 0 & otherwise ,\end{matrix} \\ {I}_{correct} ( {a}^{i , j} , {α}^{i} ) = \{ \begin{matrix}1 & if {a}^{i , j} ∈ {α}^{i} \\ 0 & otherwise ,\end{matrix} \\ {I}_{predict} ( {α}^{i , j} , {a}^{i} ) = \{ \begin{matrix}1 & \begin{matrix}if ( {I}_{call} ( {h}^{i , 1} , t ) = 1 AND {a}^{i , 1} = {α}^{i , j} ) OR \\ ( {I}_{call} ( {h}^{i , 2} , t ) = 1 AND {a}^{i , 2} = {α}^{i , j} )\end{matrix} \\ 0 & otherwise .\end{matrix}$$

We then define sensitivity and specificity as

$$sensitivity ( a ) = \frac{{\sum }_{i , j \text{:} {a}^{i , j} = a} [ {I}_{correct} ( {a}^{i , j} , {α}^{i} ) \times {I}_{call} ( {h}^{i , j} , t ) ]}{{\sum }_{i , j \text{:} {a}^{i , j} = a} {I}_{call} ( {h}^{i , j} , t )} , \\ specificity ( a ) = \frac{{\sum }_{i , j \text{:} {α}^{i , j} = a} {I}_{predict} ( {α}^{i , j} , {a}^{i} )}{{n}_{a}} .$$

Note that sensitivity can also be defined irrespective of the allele being determined i.e. for all alleles together:

$$sensitivity = \frac{{\sum }_{i , j} [ {I}_{correct} ( {a}^{i , j} , {α}^{i} ) \times {I}_{call} ( {h}^{i , j} , t ) ]}{{\sum }_{i , j} {I}_{call} ( {h}^{i , j} , t )} .$$

Results and Discussion

The statistical methodology we have developed utilises a database of haplotypes with known HLA alleles to determine the HLA alleles of additional haplotypes (or genotypes) with unknown HLA type. For the purposes of the results presented here the database consists of 300 haplotypes from individuals of European and Nigerian origin, though greater accuracy would be obtained with a larger and more widely sampled set of individuals. This methodology has two key features (see Methods). First, in making determinations, we compare a set of SNPs typed on a chromosome of unknown HLA type to those in the database, looking for extended similarity between a chromosome of unknown HLA type and one in the database, modelling the breakdown in similarity around an allele through meiotic crossing-over by using a population genetic model and current knowledge about the fine-scale recombination rate variation in the region. Using the whole-haplotype model, chromosomes carrying a particular HLA allele are modelled as an imperfect mosaic of only those haplotypes in the database that carry the same allele, effectively stratifying haplotypes into ‘subpopulations’ defined by the presence of a given HLA allele. Second, we attempt to maximise determination accuracy by selecting a set of classification SNPs from those typed in both the database and additional individuals that are maximally informative within the database about HLA alleles (i.e. that optimise determination accuracy).

This novel approach has five key advantages. First, determinations can be made at either 2-digit, 4-digit or potentially even greater resolution. Second, determinations come with associated probabilities that can be used to assess confidence in calls. Third, the method does not rely on identifying a single set of tag SNPs to be used in all experiments. One example of why this can be beneficial is that the method could be used to determine HLA alleles for individuals previously genotyped on a commercial genome-wide SNP panel. In addition, some SNPs cannot be successfully genotyped on specific platforms; hence flexibility in SNP choice is a useful property. Fourth, using the approach we can identify a set of approximately one hundred SNPs that can be used for determining HLA alleles at all loci and in any population. Finally, the approach both accommodates expansion of the existing database and suggests how to augment the database in a maximally informative manner.

To assess the potential of this approach we have used data from a recent experiment aimed at characterising SNP and class I and class II HLA allele variation in 150 unrelated individuals of Nigerian (YRI) and European ancestry (CEU: see Appendix). To select classification SNPs for HLA allele determination we use a leave-one-out cross validation strategy in the training data (see Appendix), considering SNPs up to approximately 500 kb away from the HLA locus in question (in either direction) as potentially informative. Optimised determination accuracies in the training set are shown in Table 1 for 4-digit HLA allele resolution. Excluding HLA alleles that only occur once in the training data (referred to as singletons), we obtain consistently high accuracy in determination with a typical accuracy of 90-100%. Accuracy is typically higher in CEU than YRI, particularly for HLA-B. Performance also differs between loci and is largely driven by allelic diversity. HLA-B and HLA-DRB1 typically show lower accuracy (and have the highest number of alleles), while accuracy at HLA-A, HLA-C, HLA-DQA1 and HLA-DQB1 is never lower than 94%.

The main limitation of the database used here is that many alleles are only represented once or a few times. For example, at HLA-B 42 different alleles distinct at four-digit resolution are observed across the database of 300 haplotypes, of which 14 are only observed once (across both populations). More generally, alleles represented fewer than five times in the database collectively account for about 15% of the sample. For such rare alleles, however, it may be possible to determine HLA type to 2-digit rather than 4-digit resolution. We therefore repeated the determinations of HLA alleles to 2-digit resolution (Table 1). Across all loci, only three alleles are observed as singletons at two-digit resolution and determination accuracy is generally increased by a few percent over four-digit accuracy.

For a small fraction of chromosomes, there is some uncertainty in the determined allele. This arises when the chromosome carries a SNP configuration that is similar to two or more chromosomes carrying different HLA alleles, or when the SNP configuration is unlike any previously seen. We therefore also considered accuracy when determinations were only made if the maximum posterior probability was more than 0.9 (Table 1). Setting such a threshold has little effect on most loci except for HLA-B and HLA-DRB1, where call rates are reduced, but accuracy is increased, particularly for HLA-B in YRI where accuracy increased by 10%. These results indicate that it is possible to provide useful measures of the quality of allele determinations (see also below). One use for such measures is to identify individuals where there is ambiguity in the determination (for example which fail to meet the 90% probability call threshold) and to use conventional HLA typing technologies for such individuals.

Optimised accuracy in the training set is likely to be an over-estimate of true accuracy. To validate the methodology we obtained SNP information from 911 individuals of UK origin from the 1958 birth cohort for which a subset of class I and class II HLA types were also available. These individuals had been genotyped on two separate platforms (Affymetrix and Illumina, see Appendix for details) as part of the Wellcome Trust Case Control Consortium (WTCCC) project (Nature 447:661-668). We determined HLA alleles at the typed loci using the CEU data alone and SNPs selected for performance in the training data from the overlap of the projects. Note that these SNPs represent only 10-15% of those typed in the training data.

Probabilistic determinations were made for each haplotype in the WTCCC data. 4-digit accuracy (sensitivity) is measured as the proportion of times an individual (who has been typed to 4-digit resolution at both alleles) carries a determined allele (the allele with highest maximum posterior probability). 2-digit accuracy is measured as the proportion of times an individual (who has been typed to 2-digit or 4-digit resolution at both alleles) carries a determined allele. If a call threshold is set, only those haplotypes where the highest maximum posterior probability equals or exceeds this set value are considered.

Results for the two SNP sets (from the two typing platforms) are shown in Table 2 and FIG. 3.

FIG. 3 shows the relationship between the number of times an allele appears in the database and the sensitivity and specificity of determinations at A) 4-digit and B) 2-digit resolution. Results are shown only for the Illumina-data determinations. Sensitivity is the proportion of cases where a determined allele is present in an individual. Specificity is the proportion of cases where an allele present in an individual has been correctly determined. Each allele is represented and different shades indicate the four different loci, HLA-A, HLA-B, HLA-DRB1, and HLA-DQB1. Note that two 4-digit alleles stand out as having many copies in the database and low sensitivity. It appears these alleles have only been typed to 2-digit resolution in the 1958 Birth Cohort data and so accuracy cannot be accurately determined.

With a call threshold of 0.9, accuracy at the 2-digit level is consistently greater than 95% for the Illumina array and greater than 94% for the Affymetrix array. Accuracy at 4-digit resolution varies across loci, but is consistently greater than 90%, except for HLA-DRB1 for the Affymetrix data. However, call-rates can be low for such a high call threshold. With a call threshold of 0.5 call rates are over 80% for all loci, 2-digit accuracy is over 90% for all loci (apart from HLA-B with the Affymetrix data) and 4-digit accuracy is over 85% except for HLA-DRB1.

The method also appears to be well calibrated (see FIG. 4), for example, there is a 60-70% chance of a call being correct if the maximum posterior probability for the call is in the range 0.6 to 0.7. FIG. 4 presents calibration of call probabilities in the 58 Birth Cohort data at 4-digit resolution (±2 s.e.) for the determinations made with the Affymetrix array (grey) and the Illumina array (black). The slightly higher accuracy of the Illumina data is primarily due to the higher density of SNPs from which to choose accurate classification SNP sets, particularly within the vicinity of HLA-DQB1.

Our results indicate that, for the two populations analysed here, a limited database of individuals typed at both classical HLA loci and SNP variation across the MHC region, combined with the novel statistical method presented here, can be used to determine allelic status to two and four-digit resolution at class I and class II HLA genes with up to and greater than 95% accuracy. Although for some applications, such as the choice of transplant donors, higher levels of accuracy in HLA allele determination are required, for many applications, such as testing for disease association, screening large databases for potential transplant donors or obtaining HLA alleles as covariates in vaccine trials, a small decrease in accuracy is more than compensated for by the resulting potential for reduced costs and hence increased sample sizes. Such accuracy is perhaps unexpected given the very substantial diversity and age of HLA alleles. However, while haplotype diversity is likely to lead to difficulties with a conventional tagging approach, the diversity lends itself directly to the IBD-based approach described here.

We envisage two major uses for this approach. First, we can determine HLA alleles from already-collected SNP genotype data within the MHC, such as that obtained using commercial genome-wide association study SNP panels. Second, we can identify classification SNP sets of 100-200 SNPs that can be used on either population (CEU or YRI, and potentially additional populations too) that give 4-digit resolution accuracy in the training data of over 90% at each locus. Although the choice of exactly which SNPs will most likely depend on technical details of the genotyping platform, we list a minimal classification set of 106 SNPs in Table 3. Note however, that we would not advocate use of a minimal SNP set for practical use (redundancy is important to guard against SNP assay failures).

There are, however, clear limitations in using a database of only 150 individuals to determine HLA alleles for any population. It is therefore important to estimate how large a database and how broad a geographical representation is needed to enable high accuracy determination (>95%) for any individual from any population of interest. Our results indicate that having 10 copies of an allele in the database is generally sufficient to provide high accuracy (FIG. 3). Currently, there are 2,169 unique class I and class II HLA alleles identified at the protein level (4-digit resolution), indicating that a chosen database size of 22,000 individuals would be sufficient to include at least 10 copies of each. However, many fewer individuals need be sampled to reach high coverage because each individual genotyped carries multiple alleles and many alleles are at extremely low frequency (much less than 1%). In practice, we estimate that a database of fewer than 2,000 carefully chosen individuals would be sufficient to represent the majority of HLA diversity worldwide. We have also found that information on haplotype phase from trio data is extremely valuable for reconstructing the haplotype backgrounds on which HLA alleles lie. However, it is known that using a database of known haplotypes (such as we have already) greatly aids statistical approaches to haplotype estimation. Consequently, although future sampling would benefit from pedigree-based collections, it is possible to incorporate data from unrelated individuals.

It is also clear that this method is not limited to determining HLA allelic types. It is straightforward to extend the method to include, for example, the determination of serotypes, blood groups, or the presence or absence of genes or alleles with known consequences (e.g. susceptibility or resistance to disease).

Furthermore, the invention is not limited to the individuals being human; the invention is applicable to the genes of individuals of any organism, where the genes exists in more than one form in a population of that organism, i.e. the gene has polymorphisms when analysed across the population. Thus the invention is applicable to any form of organism of any kingdom, including prokaryotes and eukaryotes, and also to viruses. The organism may be unicellular or multicellular. The organism may be an animal (such as a mammal) or plant. The invention is not limited to organisms that occur in diploid form, but includes organisms that occur in haploid form or polyploid form. Usually, the database will comprise genetic information on a population of individuals of the same species or strain as the specific individual.

Finally, it is important to acknowledge the limitations of SNP-based methods. Two important features stand out. First, although very rare, we do observe chromosomes that have nearly identical SNP patterns, yet carry different HLA alleles, perhaps due to recurrent mutation or gene conversion (although it also is impossible to rule out errors in HLA typing). Second, as discussed above, rare alleles may be absent from the database. Consequently, SNP-based determination is likely to lead to an under-estimation of heterozygosity, which is important for donor-matching and potentially also studies of selection. However, while SNP-based methods will never replace the accuracy of sequence-based typing, they can provide a high-throughput, low-cost approach to HLA-typing, useful in many experimental settings.

### APPENDIX

### Data Summary

Data used in the training set analysis have been described previously. Briefly, the individuals sampled are those of the HapMap Project, augmented with 15 parent-offspring trios from the CEPH collection. Over 7,500 SNPs and DIPs were typed across the extended human MHC, of which 5,754 passed QC in all populations surveyed. HLA typing was carried out using PCR-SSOP protocols. Haplotype information was reconstructed from genotype data using a combination of trio information and statistical methods. Missing data (at both SNPs and classical HLA alleles) was imputed during the phasing step, although haplotypes containing imputed HLA alleles are not used in the training set. All data used are publicly available on the worldwide web at inflammgen.org or sanger.ac.uk/HGP/Chr6.

The methodology was validated using genotype and HLA allele information from the 1958 birth cohort study (on the world wide web at b58cgene.sgul.ac.uk HLA alleles at HLA-A, HLA-B, HLA-DRB1 and HLA-DQB1 were obtained for approximately 930 individuals (numbers differ between loci) using DYNAL technologies from Invitrogen. Of these, 911 individuals had been successfully HLA-typed at a minimum of two loci and also had SNP genotype data available from the Wellcome Trust Case Control Consortium project. Genotyping was performed using the Affymetrix 500K SNP array set and the Illumina humanNS-12 nonsynonymous SNP panel augmented with approximately 1,500 additional SNPs specifically targeted to the MHC. Genotype calls from the image intensity files for the Affymetrix data were made using the CHIAMO software developed within the WTCCC. Haplotypes were reconstructed (and missing genotypes imputed) from genotype data using an adaptation of existing statistical methodology to include haplotypes reconstructed from the International HapMap Project data. Classification SNPs were selected in the training set from the overlap of the training set SNPs and those in the WTCCC (578 SNPs for the Affymetrix array and 776 SNPs for the Illumina array across the 8 Mb extended HLA region). Classification SNPs were selected only for 4-digit determination performance.

TABLE 1
Accuracy in determining HLA alleles in the training data

| | Accuracy at 4-digit resolution¹ (%) | | | | Accuracy at 2-digit resolution¹ (%) | | | |
|---|---|---|---|---|---|---|---|---|
| | (Call rate %) | | | | (Call rate %) | | | |
| | CT² = 0.0 | CT = 0.9 | CT = 0.0 | CT = 0.9 | CT = 0.0 | CT = 0.9 | CT = 0.0 | CT = 0.9 |
| | YRI | YRI | CEU | CEU | YRI | YRI | CEU | CEU |
| HLA-A | 96 | 98 (91) | 98 | 99 (92) | 96 | 95 (100) | 96 | 99 (93) |
| HLA-C | 97 | 97 (100) | 98 | 96 (100) | 98 | 97 (100) | 99 | 96 (100) |
| HLA-B | 91 | 100 (62) | 96 | 95 (99) | 88 | 100 (65) | 97 | 96 (100) |
| HLA- | 92 | 90 (100) | 91 | 89 (99) | 94 | 99 (88) | 97 | 95 (100) |
| DRB1 | | | | | | | | |
| HLA- | 94 | 94 (100) | 99 | 99 (100) | 96 | 96 (100) | 99 | 98 (100) |
| DQA1 | | | | | | | | |
| HLA- | 98 | 100 (98) | 99 | 99 (100) | 100 | 100 (100) | 99 | 99 (100) |
| DQB1 | | | | | | | | |

¹Excluding singleton HLA alleles
²Call threshold

TABLE 2
Determination accuracy in 1958 Birth Cohort data

| | | | | Accuracy at 4-digit | | | Accuracy at 2-digit | | |
|---|---|---|---|---|---|---|---|---|---|
| | | | | resolution (%) and call | | | resolution (%) and call rate | | |
| | | #SNPs | Number of | rate (%) | | | (%) | | |
| Locus | Data | selected | haplotypes¹ | CT = 0 | CT = 0.5 | CT = 0.9 | CT = 0 | CT = 0.5 | CT = 0.9 |
| HLA-A | Illumina | 19 | 876/1792 | 91 | 93 (97) | 94 (87) | 95 | 96 (98) | 96 (91) |
| | Affymetrix | 10 | | 89 | 91 (93) | 97 (58) | 93 | 94 (94) | 95 (29) |
| HLA-B | Illumina | 17 | 1630/1708 | 81 | 87 (81) | 94 (49) | 85 | 90 (81) | 95 (49) |
| | Affymetrix | 40 | | 82 | 85 (88) | 93 (66) | 84 | 87 (89) | 94 (65) |
| HLA- | Illumina | 18 | 834/1798 | 73 | 77 (87) | 92 (27) | 88 | 90 (88) | 97 (33) |
| DRB1 | Affymetrix | 34 | | 72 | 76 (88) | 83 (51) | 86 | 90 (88) | 95 (55) |
| HLA- | Illumina | 18 | 1088/1774 | 87 | 88 (95) | 92 (71) | 93 | 94 (96) | 96 (75) |
| DQB1 | Affymetrix | 22 | | 77 | 80 (88) | 93 (29) | 90 | 91 (89) | 97 (31) |

¹Accuracy is assessed only at those individuals where both alleles are typed to the required resolution (4-digit/2-digit)

TABLE 3
The rsIDs of the minimal classification SNP set are listed down the first column, the position on
the chromosome down the second, and the population and HLA gene along the first row. A ‘1’ in
the i, jth position of the table (ignoring the first two columns and the first row)
indicates that the ith SNP is used for determining the HLA type for the jth population and gene.

| | | | | | HLA- | HLA- | HLA- | | | | HLA- | HLA- | HLA- |
|---|---|---|---|---|---|---|---|---|---|---|---|---|---|
| | | HLA- | HLA- | HLA- | DRB1: | DQA1: | DQB1: | HLA- | HLA- | HLA- | DRB1: | DQA1: | DQB1: |
| rsID | position_b34 | A: ceu | C: ceu | B: ceu | ceu | ceu | ceu | A: yri | C: yri | B: yri | yri | yri | yri |
| rs1632933 | 29905944 | 0 | 0 | 0 | 0 | 0 | 0 | 1 | 0 | 0 | 0 | 0 | 0 |
| rs885928 | 29949566 | 1 | 0 | 0 | 0 | 0 | 0 | 0 | 0 | 0 | 0 | 0 | 0 |
| rs2844821 | 29950109 | 1 | 0 | 0 | 0 | 0 | 0 | 0 | 0 | 0 | 0 | 0 | 0 |
| rs2508042 | 29994117 | 1 | 0 | 0 | 0 | 0 | 0 | 0 | 0 | 0 | 0 | 0 | 0 |
| rs2157680 | 30018226 | 1 | 0 | 0 | 0 | 0 | 0 | 0 | 0 | 0 | 0 | 0 | 0 |
| rs3823339 | 30018808 | 1 | 0 | 0 | 0 | 0 | 0 | 0 | 0 | 0 | 0 | 0 | 0 |
| rs3823343 | 30018951 | 1 | 0 | 0 | 0 | 0 | 0 | 1 | 0 | 0 | 0 | 0 | 0 |
| rs1061235 | 30019138 | 1 | 0 | 0 | 0 | 0 | 0 | 0 | 0 | 0 | 0 | 0 | 0 |
| rs2499 | 30019382 | 1 | 0 | 0 | 0 | 0 | 0 | 0 | 0 | 0 | 0 | 0 | 0 |
| rs6921314 | 30020060 | 1 | 0 | 0 | 0 | 0 | 0 | 0 | 0 | 0 | 0 | 0 | 0 |
| rs2735097 | 30021141 | 0 | 0 | 0 | 0 | 0 | 0 | 1 | 0 | 0 | 0 | 0 | 0 |
| rs7745413 | 30021309 | 1 | 0 | 0 | 0 | 0 | 0 | 1 | 0 | 0 | 0 | 0 | 0 |
| rs1632880 | 30023450 | 1 | 0 | 0 | 0 | 0 | 0 | 0 | 0 | 0 | 0 | 0 | 0 |
| rs7747114 | 30025614 | 1 | 0 | 0 | 0 | 0 | 0 | 0 | 0 | 0 | 0 | 0 | 0 |
| rs1655912 | 30026305 | 1 | 0 | 0 | 0 | 0 | 0 | 0 | 0 | 0 | 0 | 0 | 0 |
| rs3893538 | 30030261 | 1 | 0 | 0 | 0 | 0 | 0 | 0 | 0 | 0 | 0 | 0 | 0 |
| rs2256543 | 30043671 | 1 | 0 | 0 | 0 | 0 | 0 | 1 | 0 | 0 | 0 | 0 | 0 |
| rs6457116 | 30043863 | 1 | 0 | 0 | 0 | 0 | 0 | 0 | 0 | 0 | 0 | 0 | 0 |
| rs7754245 | 30044316 | 0 | 0 | 0 | 0 | 0 | 0 | 1 | 0 | 0 | 0 | 0 | 0 |
| rs2523969 | 30044615 | 1 | 0 | 0 | 0 | 0 | 0 | 0 | 0 | 0 | 0 | 0 | 0 |
| rs435766 | 30045689 | 1 | 0 | 0 | 0 | 0 | 0 | 0 | 0 | 0 | 0 | 0 | 0 |
| rs2894003 | 30052418 | 1 | 0 | 0 | 0 | 0 | 0 | 0 | 0 | 0 | 0 | 0 | 0 |
| rs3915798 | 30058271 | 0 | 0 | 0 | 0 | 0 | 0 | 1 | 0 | 0 | 0 | 0 | 0 |
| rs5875226 | 30059808 | 0 | 0 | 0 | 0 | 0 | 0 | 1 | 0 | 0 | 0 | 0 | 0 |
| rs9468675 | 30066556 | 0 | 0 | 0 | 0 | 0 | 0 | 1 | 0 | 0 | 0 | 0 | 0 |
| rs1345274 | 31296875 | 0 | 0 | 0 | 0 | 0 | 0 | 0 | 1 | 0 | 0 | 0 | 0 |
| rs3869115 | 31310909 | 0 | 1 | 0 | 0 | 0 | 0 | 0 | 0 | 0 | 0 | 0 | 0 |
| rs3868082 | 31313896 | 0 | 1 | 0 | 0 | 0 | 0 | 0 | 0 | 0 | 0 | 0 | 0 |
| rs3130425 | 31323067 | 0 | 0 | 0 | 0 | 0 | 0 | 0 | 0 | 1 | 0 | 0 | 0 |
| rs3130542 | 31336843 | 0 | 1 | 0 | 0 | 0 | 0 | 0 | 0 | 0 | 0 | 0 | 0 |
| rs2844623 | 31337305 | 0 | 1 | 0 | 0 | 0 | 0 | 0 | 0 | 0 | 0 | 0 | 0 |
| rs2248902 | 31338876 | 0 | 1 | 0 | 0 | 0 | 0 | 0 | 0 | 0 | 0 | 0 | 0 |
| rs2524100 | 31340517 | 0 | 1 | 0 | 0 | 0 | 0 | 0 | 1 | 0 | 0 | 0 | 0 |
| rs2853950 | 31340923 | 0 | 1 | 0 | 0 | 0 | 0 | 0 | 1 | 0 | 0 | 0 | 0 |
| rs2001181 | 31341746 | 0 | 1 | 0 | 0 | 0 | 0 | 0 | 1 | 0 | 0 | 0 | 0 |
| rs7383157 | 31344054 | 0 | 1 | 0 | 0 | 0 | 0 | 0 | 0 | 0 | 0 | 0 | 0 |
| rs2074491 | 31344644 | 0 | 1 | 0 | 0 | 0 | 0 | 0 | 0 | 0 | 0 | 0 | 0 |
| rs6457358 | 31344747 | 0 | 1 | 0 | 0 | 0 | 0 | 0 | 0 | 0 | 0 | 0 | 0 |
| rs2524094 | 31344789 | 0 | 0 | 0 | 0 | 0 | 0 | 0 | 1 | 0 | 0 | 0 | 0 |
| rs2074489 | 31344876 | 0 | 1 | 0 | 0 | 0 | 0 | 0 | 1 | 0 | 0 | 0 | 0 |
| rs2074488 | 31345179 | 0 | 1 | 0 | 0 | 0 | 0 | 0 | 0 | 0 | 0 | 0 | 0 |
| rs7759127 | 31345736 | 0 | 1 | 0 | 0 | 0 | 0 | 0 | 0 | 0 | 0 | 0 | 0 |
| rs6923313 | 31346118 | 0 | 0 | 0 | 0 | 0 | 0 | 0 | 1 | 0 | 0 | 0 | 0 |
| rs3130696 | 31348627 | 0 | 1 | 0 | 0 | 0 | 0 | 0 | 1 | 0 | 0 | 0 | 0 |
| rs2524074 | 31348764 | 0 | 0 | 0 | 0 | 0 | 0 | 0 | 1 | 0 | 0 | 0 | 0 |
| rs2524069 | 31349532 | 0 | 0 | 1 | 0 | 0 | 0 | 0 | 0 | 0 | 0 | 0 | 0 |
| rs9348859 | 31354709 | 0 | 1 | 0 | 0 | 0 | 0 | 0 | 0 | 0 | 0 | 0 | 0 |
| rs3873379 | 31366897 | 0 | 0 | 0 | 0 | 0 | 0 | 0 | 0 | 1 | 0 | 0 | 0 |
| rs2844586 | 31422213 | 0 | 0 | 0 | 0 | 0 | 0 | 0 | 0 | 1 | 0 | 0 | 0 |
| rs2523619 | 31422333 | 0 | 0 | 1 | 0 | 0 | 0 | 0 | 0 | 0 | 0 | 0 | 0 |
| rs2523618 | 31422492 | 0 | 0 | 1 | 0 | 0 | 0 | 0 | 0 | 0 | 0 | 0 | 0 |
| rs2442719 | 31424730 | 0 | 0 | 1 | 0 | 0 | 0 | 0 | 0 | 0 | 0 | 0 | 0 |
| rs2596503 | 31425002 | 0 | 0 | 1 | 0 | 0 | 0 | 0 | 0 | 1 | 0 | 0 | 0 |
| rs2596501 | 31425403 | 0 | 0 | 0 | 0 | 0 | 0 | 0 | 0 | 1 | 0 | 0 | 0 |
| rs1058026 | 31425877 | 0 | 0 | 1 | 0 | 0 | 0 | 0 | 0 | 1 | 0 | 0 | 0 |
| rs2769 | 31426074 | 0 | 0 | 1 | 0 | 0 | 0 | 0 | 0 | 1 | 0 | 0 | 0 |
| rs3819300 | 31426495 | 0 | 0 | 1 | 0 | 0 | 0 | 0 | 0 | 1 | 0 | 0 | 0 |
| rs3819299 | 31426559 | 0 | 0 | 1 | 0 | 0 | 0 | 0 | 0 | 1 | 0 | 0 | 0 |
| rs3819294 | 31426679 | 0 | 0 | 1 | 0 | 0 | 0 | 0 | 0 | 1 | 0 | 0 | 0 |
| rs2523608 | 31426751 | 0 | 0 | 1 | 0 | 0 | 0 | 0 | 0 | 1 | 0 | 0 | 0 |
| rs3819285 | 31426934 | 0 | 0 | 1 | 0 | 0 | 0 | 0 | 0 | 0 | 0 | 0 | 0 |
| rs3819284 | 31426959 | 0 | 0 | 1 | 0 | 0 | 0 | 0 | 0 | 1 | 0 | 0 | 0 |
| rs1051488 | 31427103 | 0 | 0 | 1 | 0 | 0 | 0 | 0 | 0 | 0 | 0 | 0 | 0 |
| rs2394985 | 31427747 | 0 | 0 | 0 | 0 | 0 | 0 | 0 | 0 | 1 | 0 | 0 | 0 |
| rs3998357 | 31431253 | 0 | 0 | 0 | 0 | 0 | 0 | 0 | 0 | 1 | 0 | 0 | 0 |
| rs2596438 | 31444042 | 0 | 0 | 0 | 0 | 0 | 0 | 0 | 0 | 1 | 0 | 0 | 0 |
| rs2507987 | 31447204 | 0 | 0 | 1 | 0 | 0 | 0 | 0 | 0 | 0 | 0 | 0 | 0 |
| rs9266791 | 31463126 | 0 | 0 | 1 | 0 | 0 | 0 | 0 | 0 | 0 | 0 | 0 | 0 |
| rs7751505 | 31464441 | 0 | 0 | 1 | 0 | 0 | 0 | 0 | 0 | 0 | 0 | 0 | 0 |
| rs2256028 | 31483398 | 0 | 0 | 1 | 0 | 0 | 0 | 0 | 0 | 0 | 0 | 0 | 0 |
| rs9268516 | 32450662 | 0 | 0 | 0 | 0 | 0 | 0 | 0 | 0 | 0 | 1 | 0 | 0 |
| rs2395175 | 32476248 | 0 | 0 | 0 | 1 | 1 | 0 | 0 | 0 | 0 | 0 | 0 | 0 |
| rs2395178 | 32476584 | 0 | 0 | 0 | 0 | 0 | 0 | 0 | 0 | 0 | 1 | 0 | 0 |
| rs2239804 | 32482746 | 0 | 0 | 0 | 1 | 0 | 0 | 0 | 0 | 0 | 0 | 0 | 0 |
| rs3135388 | 32484240 | 0 | 0 | 0 | 1 | 0 | 0 | 0 | 0 | 0 | 0 | 0 | 0 |
| rs7452076 | 32486270 | 0 | 0 | 0 | 0 | 0 | 1 | 0 | 0 | 0 | 0 | 0 | 0 |
| rs2395185 | 32504360 | 0 | 0 | 0 | 1 | 0 | 0 | 0 | 0 | 0 | 1 | 0 | 0 |
| rs2187823 | 32510706 | 0 | 0 | 0 | 0 | 0 | 0 | 0 | 0 | 0 | 1 | 0 | 0 |
| rs5026743 | 32511162 | 0 | 0 | 0 | 0 | 0 | 0 | 0 | 0 | 0 | 1 | 0 | 0 |
| rs6901541 | 32513462 | 0 | 0 | 0 | 0 | 1 | 0 | 0 | 0 | 0 | 0 | 1 | 0 |
| rs5020946 | 32521277 | 0 | 0 | 0 | 1 | 0 | 0 | 0 | 0 | 0 | 0 | 0 | 0 |
| rs6932266 | 32532340 | 0 | 0 | 0 | 0 | 0 | 0 | 0 | 0 | 0 | 1 | 0 | 0 |
| rs2894266 | 32536120 | 0 | 0 | 0 | 1 | 0 | 0 | 0 | 0 | 0 | 1 | 0 | 0 |
| rs11754052 | 32563120 | 0 | 0 | 0 | 1 | 0 | 0 | 0 | 0 | 0 | 0 | 0 | 0 |
| rs7753605 | 32612642 | 0 | 0 | 0 | 0 | 1 | 1 | 0 | 0 | 0 | 0 | 0 | 0 |
| rs7451962 | 32633927 | 0 | 0 | 0 | 1 | 1 | 0 | 0 | 0 | 0 | 1 | 1 | 0 |
| rs2097432 | 32642277 | 0 | 0 | 0 | 1 | 0 | 0 | 0 | 0 | 0 | 0 | 0 | 0 |
| rs3129763 | 32642431 | 0 | 0 | 0 | 1 | 0 | 0 | 0 | 0 | 0 | 0 | 0 | 0 |
| rs4639334 | 32653366 | 0 | 0 | 0 | 1 | 1 | 0 | 0 | 0 | 0 | 0 | 1 | 0 |
| rs5875382 | 32653817 | 0 | 0 | 0 | 0 | 0 | 1 | 0 | 0 | 0 | 1 | 1 | 1 |
| rs2040410 | 32653850 | 0 | 0 | 0 | 0 | 0 | 0 | 0 | 0 | 0 | 1 | 0 | 0 |
| rs2187668 | 32657047 | 0 | 0 | 0 | 0 | 1 | 0 | 0 | 0 | 0 | 0 | 1 | 0 |
| rs6927022 | 32663617 | 0 | 0 | 0 | 0 | 1 | 0 | 0 | 0 | 0 | 0 | 1 | 0 |
| rs6906021 | 32672361 | 0 | 0 | 0 | 0 | 0 | 1 | 0 | 0 | 0 | 0 | 0 | 1 |
| rs1064173 | 32673520 | 0 | 0 | 0 | 0 | 0 | 1 | 0 | 0 | 0 | 0 | 0 | 0 |
| rs1063355 | 32673754 | 0 | 0 | 0 | 0 | 0 | 0 | 0 | 0 | 0 | 1 | 1 | 1 |
| rs2854276 | 32674218 | 0 | 0 | 0 | 0 | 0 | 1 | 0 | 0 | 0 | 0 | 0 | 0 |
| rs3134996 | 32683288 | 0 | 0 | 0 | 0 | 0 | 1 | 0 | 0 | 0 | 0 | 0 | 1 |
| rs4947342 | 32699490 | 0 | 0 | 0 | 0 | 0 | 1 | 0 | 0 | 0 | 0 | 0 | 0 |
| rs5875390 | 32703793 | 0 | 0 | 0 | 1 | 0 | 0 | 0 | 0 | 0 | 0 | 0 | 0 |
| rs6457617 | 32710272 | 0 | 0 | 0 | 0 | 0 | 1 | 0 | 0 | 0 | 0 | 0 | 0 |
| rs2647012 | 32710879 | 0 | 0 | 0 | 0 | 0 | 0 | 0 | 0 | 0 | 0 | 0 | 1 |
| rs2647045 | 32714501 | 0 | 0 | 0 | 0 | 0 | 0 | 0 | 0 | 0 | 0 | 0 | 1 |
| rs7764856 | 32727018 | 0 | 0 | 0 | 1 | 1 | 0 | 0 | 0 | 0 | 0 | 1 | 0 |
| rs3998159 | 32728398 | 0 | 0 | 0 | 0 | 0 | 0 | 0 | 0 | 0 | 0 | 1 | 0 |
| rs3997854 | 32729294 | 0 | 0 | 0 | 0 | 0 | 0 | 0 | 0 | 0 | 0 | 0 | 1 |
| Mean | NA | 98 | 98 | 96 | 91 | 99 | 99 | 96 | 97 | 91 | 92 | 94 | 98 |
| determination | | | | | | | | | | | | | |
| accuracy_% | | | | | | | | | | | | | |

1.-26. (canceled)

27. A method for determining an allelic type of a specific individual, comprising:
accessing, by a computer system, a database of genetic information on a plurality of individuals, the genetic information comprising: the allelic type of each individual; and the type of each of a plurality of genetic markers for each individual;
categorizing, by a computer system, the data in the database into a plurality of groups of individuals, such that all individuals having the same allelic type are in the same group, and each group represents a different allelic type;
inputting data into a computer system, the data comprising the type of each of a plurality of genetic markers of the specific individual, wherein the specific individual has an unknown allelic type;
specifying, by a computer system, a set of genetic markers for which type information is known both for the individuals in the database and for the specific individual;
evaluating, by a computer system, for some or all of the groups in turn, using a population genetic model, a likelihood function of the input data of the types of the specified set of genetic markers for the specified individual; and
determining, by a computer system, one or more allelic types of the specific individual based on the evaluated likelihood function.

28. A method according to claim 27, comprising using the likelihood function to calculate the probability that the specific individual has one or more of the different allelic types.

29. A method according to claim 28, comprising incorporating prior knowledge of the probability that the specific individual carries a given allele in the calculation of the probability that the specific individual has one or more of the different allelic types.

30. A method according to claim 28, comprising determining that the allelic type of the specific individual is the same as the allelic type of the individuals in the group for which the calculated probability of sampling the input type data is highest.

31. A method according to claim 30, wherein the allelic type is only determined if the probability exceeds a predetermined threshold.

32. A method according to claim 27, wherein the population genetic model includes at least one of the following parameters: recombination rate, mutation rate, gene conversion, admixture, migration, selection and marker positions.

33. A method for selecting a set of genetic markers for use in determining an allelic type of a specific individual, the method comprising:
accessing, by a computer system, a database of genetic information on a plurality of individuals, the genetic information comprising: the allelic type of each individual; and the type of each of a plurality of genetic markers for each individual;
specifying a current set of one or more genetic markers for which type information is known;
determining, by a computer system, the allelic type of an individual in the database using the current set of genetic markers by
categorizing the data in the database into a plurality of groups of individuals, such that individuals having the same allelic type are in the same group, and each group represents a different allelic type,
evaluating, for some or all of the groups in turn, using a population genetic model, a likelihood function of the input data of the types of the specified set of genetic markers for the specified individual;
assessing the allelic type of the individual in the database based on the evaluated likelihood function;
measuring, by a computer system, the effectiveness of the current set of genetic markers to classify an allelic type by calculating a performance measure on the basis of the allelic types found in the determining step and the actual allelic types known from the database;
keeping, by a computer system, as the current set of markers a set that most effectively classifies an allelic type based on the performance measure;
modifying, by a computer system, the current set of genetic markers, wherein genetic markers are added and/or removed from the set;
repeating the determining, measuring, keeping and modifying steps;
terminating when a predetermined condition is met; and
outputting, by a computer system, a final set of genetic markers that most effectively classifies an allelic type.

34. A method according to claim 33, comprising treating each individual in the database in turn as an individual of unknown allelic type, wherein the allelic type of that individual is determined on the basis of the data on the remaining individuals in the database.

35. A method of determining an allelic type of a specific individual according to claim 27, further comprising determining the type of each of the genetic markers of the specified set of genetic markers of a DNA sample of the specific individual as the data for inputting in the inputting step.

36. A method according to claim 27, wherein the step of specifying a set of genetic markers comprises:
specifying a current set of one or more genetic markers for which type information is known;
determining the allelic type of each individual in the database using the current set of genetic markers by
categorizing the data in the database into a plurality of groups of individuals, such that all individuals having the same allelic type are in the same group, and each group represents a different allelic type,
evaluating, for some or all of the groups in turn using a population genetic model, a likelihood function of the input data of the types of the specified set of genetic markers for the specified individual; and
assessing the allelic type of the individual in the database based on the likelihood function;
measuring the effectiveness of the current set of genetic markers to classify an allelic type by calculating a performance measure on the basis of the allelic types found in the determining step and the actual allelic types known from the database;
keeping as the current set of markers the set most effectively classifies an allelic type based on the performance measure;
modifying the current set of genetic markers, wherein genetic markers are added and/or removed from the set;
repeating the determining, measuring, keeping and modifying steps;
terminating when a predetermined condition is met; and
outputting a final set of genetic markers that most effectively classifies an allelic type.

37. A method of determining an allelic type of a specific individual, comprising:
determining the allelic type using the genetic markers of a specified set of genetic markers in a DNA sample from the specific individual, wherein the set of genetic markers are selected according to the method of claim 33.

38. A method according claim 27, wherein the genetic markers comprise one or more of: SNPs, insertions, deletions, deletion-insertion polymorphisms (DIPs), microsatellites, and short tandem repeats.

39. A method according claim 38, wherein the markers are known at the resolution of genotype or haplotype.

40. A method according to claim 27, wherein the genetic markers comprise haplotype information, and wherein haplotype phase is determined before applying the method or is imputed in the course of applying the method.

41. A method according to claim 27, wherein instead of determining allelic type, a function or manifestation of allelic type is determined.

42. A method according to claim 41, wherein the function or manifestation of allelic type comprises at least one of serotype, blood group, susceptibility to a disease, resistance to a disease, presence or absence of a gene or allele with known consequence.

43. A method according to claim 27, wherein the allelic type to be determined is part of the Major Histocompatability Complex.

44. A method according to claim 27, comprising determining, by a computer system, the Human Leukocyte Antigen allelic type of the specific individual.

45. The method of claim 27, wherein the set of genetic markers comprises at least one, or at least 10, or at least 20, or at least 50, or at least 80, or all SNP positions specified in Table 3.

46. A non-transitory computer-readable medium having instructions stored thereon, wherein the instructions cause the computer system to perform a method according to claim 27.
